(19) United States
(12) Patent Application Publication
(10) Pub. No.: US 2004/0263644 A1
(43) Pub. Date: Dec. 30, 2004

(54) Electronic apparatus, directory generating method, directory reading method and computer program

(76) Inventor: Junsuke Ebi, Kanagawa (JP)

Correspondence Address: JAY H. MAIOLI, Cooper & Dunham LLP, 1185 Avenue of the Americas, New York, NY, 10036, US

(21) Appl. No.: 10/853,334

(22) Filed: May 25, 2004

(30) Foreign Application Priority Data
Jun. 3, 2003 (JP) P2003-157680

(51) Int. Cl. H04N 5/91

(52) U.S. Cl. 348/231.2

(57) ABSTRACT

An electronic apparatus, a directory generating method for the electronic apparatus, a directory reading method, and a computer program easily provide compatibility between file formats providing enhanced speed search functions using new index files and file formats of the related art, such as the Exif standard, without generating separate files to provide compatibility.

### CROSS REFERENCE TO RELATED APPLICATIONS

The present document is based on Japanese Priority Application JP2003-157680 filed in the Japanese Patent Office on Jun. 3, 2003, the contents in which being incorporated herein by reference to the extent permitted by law.

### BACKGROUND OF THE INVENTION

1. Field of the Invention

The present invention relates to electronic apparatus such as a digital camera, and a directory generating method, directory reading method, and computer program that can be used with this electronic apparatus.

2. Related Art

Conventionally, almost all digital cameras constituting as concerning electronic apparatuses record data into semiconductor media in accordance with the Exif (Exchangeableimage file format) standard, with reading time taking longer as the content number on the Exif standard character becomes large. However, recently, the number of items of content it is made possible to record has increased as recording capacity has increased year by year.

With new apparatuses, content reading time can be reduced by using a dedicated index file, but in this case,

With new apparatuses, content reading time can be reduced by using a dedicated index file, but in this case, recognition of, for example, the presence of a still image file using the index file is the standard.

Because of this, still image files made only using, for example, the Exif standard cannot be recognized by the new electronic apparatus which recognizes the presence of still image files using index files.

Electronic apparatuses having compatibility between file formats different to the Exif standard have also been considered in order to resolve such problem. For example, refer to patent Japanese Patent Laid-open Publication No. 2002-204420 (paragraph [0015], FIG. 2).

### SUMMARY OF THE INVENTION

However, with the electronic apparatus disclosed in, for example, Japanese Patent Publication Laid-open No. 2002-204420 mentioned above, it is necessary to generate a separate thumbnail file for use with a thumbnail image in addition to the existing file, and the steps therefore increase.

In order to resolve the aforementioned problems, the present invention has been conceived to provide an electronic apparatus, a directory generating method used in this electronic apparatus, a directory reading method, and a computer program capable of easily providing compatibility between file formats providing enhanced speed search functions using new index files and file formats of the related art such as, for example, the Exif standard without generating separate files to provide compatibility.

In order to achieve the aforementioned object, an electronic apparatus according to an aspect of the present invention is characterized by first generating means for generating a first subdirectory under a root directory for relating an index file for input information to the root directory, and second generating means capable of generating a second subdirectory relating at least part of an actual file for the input information to the root directory in parallel with the first subdirectory.

Here, “index file” describes, for example, “AVIV00001.MQV” etc. and is a file collecting information identifying the content of one or more files etc., and “first subdirectory” describes, for example, MQ ROOT etc., and is a directory generated under the root directory. Further, “actual file” is a still image file etc. described as, for example, “NRQ00001.JPG” etc., and “second subdirectory” is a directory described as, for example, “DCIM” etc. generated under the root directory.

“DCIM” stands for Digital Camera IMages, and “Directory” refers to items recorded with file management information (name, organization method, data format, information security level, recording location, etc.) recorded on a recording medium such as, for example, a hard disc, or floppy (registered trademark) disc, etc.

According to a preferred embodiment of the present invention, there is provided first generating means for generating a first subdirectory under a root directory for relating an index file for input information with the root directory, and second generating means for generating a second subdirectory relating at least part of an actual file for the input information in parallel with the first subdirectory. It is therefore possible to read out actual files using, for example, a conventional Exif standard while providing an enhanced speed search function using the index file even if separate files for interchanging are not generated, and interchanging between different file formats can therefore be achieved in a straightforward manner at reduced cost.

According to an embodiment of the present invention, the first generating means is capable of generating the index file under the first subdirectory, and the second generating means is capable of generating at least part of the actual file for the input information under the second subdirectory. In this way, it is made possible to generate an index file for the input information below the first subdirectory, and generate at least part of an actual file for the input information below the second subdirectory. It is therefore possible to generate, for example, “AVIS00001.MQV” for still image use as an index file for the input information below the first subdirectory, and generate “NRQ00001.JPG” below the second subdirectory as this actual file. It is therefore possible to read “NRQ00001.JPG” for an actual file either in cases employing index files or cases employing a conventional, for example, Exif standard.

According to an embodiment of the present invention, the actual file corresponds to at least part of information within the index file. As a result, it is made possible to achieve an interchangeable file structure where it is made possible to read the same actual file using the index file, and it is made possible to read using, for example, a conventional Exif standard.

According to another embodiment of the present invention, the present invention is characterized by recording means for recording at least the root directory, the first subdirectory generated by the first generating means and the index file, and the second subdirectory generated by the second generating means and actual file on a portable recording medium. In this way, with a file structure where it is made possible to read in actual files using, for example, a conventional Exif standard while providing a enhanced speed search function using an index file, it is made possible to record and save image information to a portable recording medium such as, for example, a memory card etc. As a result, image information etc. can be inputted to other electronic apparatus from this recording medium, at least an actual file employing, for example, an Exif standard for this image information can be seen using this electronic apparatus, and interchangeability is increased.

According to still another embodiment of the present invention, the input information has image information, and at least the second subdirectory is based on an image file format standard for use with a digital camera. As a result, for example, the still image file is generated using the most typical digital still camera image file format standard (Exif (Exchangeableimage file format) standard) so that just about all electronic apparatus is capable of reading this still image file, so as to further achieve interchangeability.

An electronic apparatus according to a further aspect of the present invention is characterized by first reading means capable of reading a first subdirectory relating an index file for input information to a root directory generated under the root directory, and second reading means capable of reading a second subdirectory relating at least part of an actual file for the input information to a root directory generated under the root directory in parallel with the first subdirectory.

According to another preferred embodiment of the present invention, there is provided first reading means for reading a first subdirectory generated under a root directory so as to relate an index file for input information, and second reading means for reading a second subdirectory generated so as to relate at least part of an actual file for the input information in parallel with the first subdirectory. It is therefore made possible to read out actual files using, for example, a conventional Exif standard while providing an enhanced speed search function using the index file even if separate files for interchanging are not generated, and interchanging between different file formats can therefore be achieved in a straightforward manner at reduced cost.

According to this embodiment of the present invention, the first reading means is capable of reading the index file generated under the first subdirectory, and the second reading means is capable of reading at least part of the actual file for the input information generated under the second subdirectory. In this way, it is made possible to read an index file under the first subdirectory, and read an actual file under the second subdirectory. It is therefore possible to read, for example, “AVIS00001.MQV” for still image use as an index file under the first subdirectory, and read “INRQ00001.JPG” below the second subdirectory as this actual file. It is therefore possible to read “NRQ00001.JPG” for an actual file either in cases employing index files or cases employing a conventional, for example, Exif standard.

According to another preferred embodiment of the present invention, the second reading means reads out the actual file based on information within the index file read in by the first reading means. As a result, it is made possible to search, for example, actual files for the still images using a conventional Exif standard generated so as to be compatible with information within the index file at enhanced speed using the index file.

According to still another preferred embodiment of the present invention, the second reading means reads out the actual file based on information within the second subdirectory read in by the second reading means. In this way, for example, it is made possible to read out actual files for still images using the conventional Exif standard generated so as to be compatible with information within the index file using electronic apparatus following a conventional, for example, Exif standard, which enables straightforward interchangeability between different file formats so as to achieve reduced costs.

According to still another preferred embodiment of the present invention, the second reading means has selection means capable of selecting whether or not to read-in using this reading means, and reads in the actual file for the input information generated under the second subdirectory using selection information from this selection means. As a result, for example, the actual file is searched using the index file, and a reproduction method can be selected in order to read the actual file so as to follow, for example, the conventional Exif standard as necessary afterwards. This increases interchangeability between different file formats.

According to another preferred embodiment of the present invention, the selection means has determining means for determining whether or not an actual file is generated under the second directory, with the selection means being restricted if the determining means determines that the actual file has not been generated. In this way, if the actual file is first searched using the index file and the actual file is read out following the conventional Exif standard afterwards, if it is determined that the actual file, for example, has not been generated under the DCIM directory, for example, the select button is not displayed so that unnecessary processing is avoided, and the user can easily be notified that the actual file is not present.

Furthermore, the determining means is capable of determining whether or not an actual file is generated under the second subdirectory based on information within the index file read in by the first reading means. As a result, by adding a flag showing that an actual file has not been generated in information within, for example, the index file, it is made possible to restrict selection of a reproduction method for reading actual files following a conventional Exif standard by reading the first index file.

According to further another embodiment of the present invention, the input information has image information, and at least the second subdirectory is based on an image file format standard for use with a digital camera. As a result, for example, reading of image files according to a conventional Exif standard is made possible, and it is therefore possible to improve exchangeability while providing an enhanced speed search function using an index file.

A directory reading method according to a further preferred embodiment of the present invention is characterized by a first generating step of generating a first subdirectory for relating an index file for input information to a root directory under the root directory, and a second generating step capable of generating a second subdirectory relating at least part of an actual file for the input information to the root directory in parallel with the first subdirectory.

According to a preferred embodiment of the present invention, there is provided a first generating step of generating a first subdirectory for relating an index file for input information below a root directory, and a second generating step of generating a second subdirectory relating at least part of an actual file for the input information in parallel with the first subdirectory. It is therefore possible to read out actual files using, for example, a conventional Exif standard while providing an enhanced speed search function using the index file even if separate files for interchanging are not generated, and interchanging between different file formats can therefore be achieved in a straightforward manner at reduced cost.

A directory reading method according to a further preferred embodiment of the present invention is characterized by a first reading step capable of reading a first subdirectory relating an index file for input information to a root directory generated under the root directory, and a second reading step capable of reading a second subdirectory relating at least part of an actual file for the input information to a root directory generated under the root directory in parallel with the first subdirectory.

According to a preferred embodiment of the present invention, there is provided a first reading step of reading a first subdirectory generated so as to relate an index file for input information below a root directory, and a second reading step of reading a second subdirectory generated so as to relate at least part of an actual file for the input information in parallel with the first subdirectory. It is therefore possible to read out actual files using, for example, a conventional Exif standard while providing an enhanced speed search function using the index file even if separate files for interchanging are not generated, and interchanging between different file formats can therefore be achieved in a straightforward manner at reduced cost.

A computer program according to a further preferred embodiment of the present invention is characterized by executing a first generating step of generating a first subdirectory for relating an index file for input information to a root directory under the root directory, and a second generating step capable of generating a second subdirectory relating at least part of an actual file for the input information to the root directory in parallel with the first subdirectory on a computer.

According to a preferred embodiment of the present invention, there is provided a first generating step of generating a first subdirectory for relating an index file for input information below a root directory, and a second generating step capable of generating a second subdirectory relating at least part of an actual file for the input information in parallel with the first subdirectory. By using the computer program, it is therefore possible to read out actual files using, for example, a conventional Exif standard while providing an enhanced speed search function using the index file even if separate files for interchanging are not generated, and interchanging between different file formats can therefore be achieved in a straightforward manner at reduced cost.

A computer program according to a further preferred embodiment of the present invention is characterized by executing a first reading step capable of reading a first subdirectory relating an index file for input information to a root directory generated under the root directory, and a second reading step capable of reading a second subdirectory relating at least part of an actual file for the input information to a root directory generated under the root directory in parallel with the first subdirectory on a computer.

According to another preferred embodiment of the present invention, there is provided a first reading step of reading a first subdirectory generated so as to relate an index file for input information below a root directory, and a second reading step of reading a second subdirectory generated so as to relate at least part of an actual file for the input information in parallel with the first subdirectory. By employing the computer, it is made possible to read out actual files using, for example, a conventional Exif standard while providing an enhanced speed search function using the index file even if separate files for interchanging are not generated, and interchanging between different file formats can therefore be achieved in a straightforward manner at reduced cost.

As described above, with the present invention, it is made possible to easily exchange file formats provided by enhanced speed search functions using index files and file formats such as, for example, conventional Exif standard formats.

### BRIEF DESCRIPTION OF THE DRAWINGS

The above and other features and advantages of the present invention will become more apparent from the following description of the presently exemplary preferred embodiment of the present invention taken in conjunction with the accompanying drawings, in which:

FIG. 1 shows an outline perspective view viewed from the operation side of a digital camera according to a first preferred embodiment of the present invention;

FIG. 2 shows an outline perspective view viewed from the imaging unit side of a digital camera of the first preferred embodiment of the present invention;

FIG. 3 shows a block view centered on a control unit of the digital camera of the first preferred embodiment of the present invention;

FIG. 4 shows a view illustrating a directory file structure generated by the digital camera of the first preferred embodiment of the present invention;

FIG. 5 shows a flowchart for the case of recording image information on a recording medium using a digital camera of the first preferred embodiment of the present invention;

FIG. 6 shows a view illustrating a case of reproducing on electronic apparatus employing another standard after recording on a recording medium using the digital camera of the first preferred embodiment of the present invention;

FIG. 7 shows a view illustrating a case of recording on a recording medium using electronic apparatus employing another standard after recording on a recording medium using the digital camera of the first preferred embodiment of the present invention;

FIG. 8 shows a flowchart for the case of reproducing image information recorded on a recording medium using a digital camera of the first preferred embodiment of the present invention;

FIG. 9 shows a view illustrating a menu screen of a digital camera of the first preferred embodiment of the present invention;

FIG. 10 shows a view illustrating other types of apparatus reproduction menu screen of a digital camera of the first preferred embodiment of the present invention;

FIG. 11 shows a view illustrating a directory structure where actual files for a still image do not exist.

FIG. 12 shows a view illustrating a directory structure where an index file for a still image does not exist but an actual file for a still image does exist; and

FIG. 13 shows a view describing a case of acquiring actual data for a still image via a file storing only management information using the index file information.

### DESCRIPTION OF THE PREFERRED EMBODIMENTS OF THE INVENTION

The following is a description based on the drawings of the preferred embodiments of the present invention. In the following description of preferred embodiments, a description is given centered on a digital camera using a recording medium taken as an example of electronic apparatus, but the present invention is by no means limited in this respect.

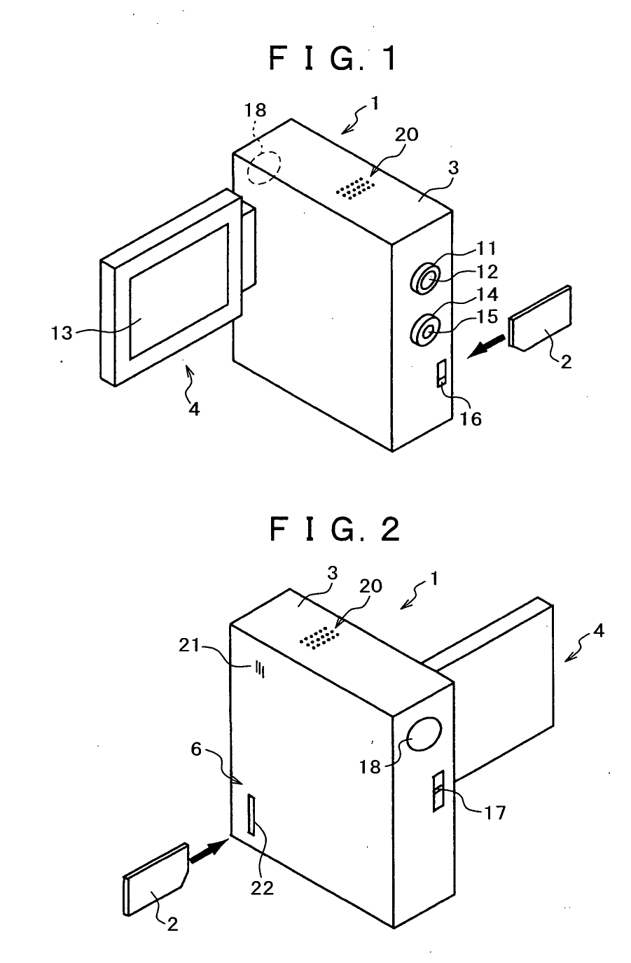

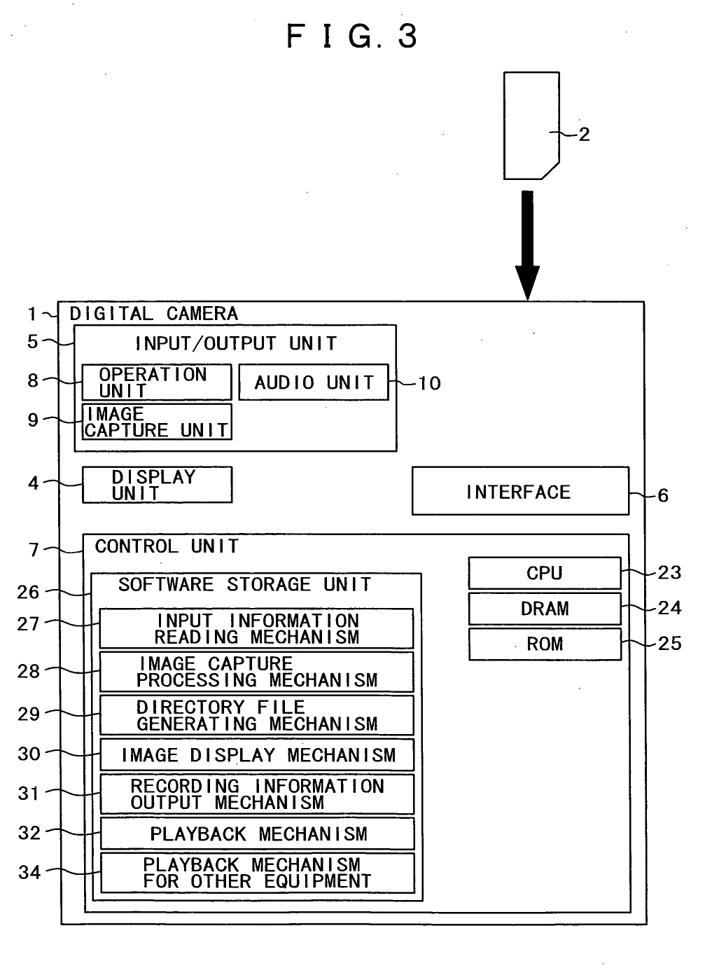

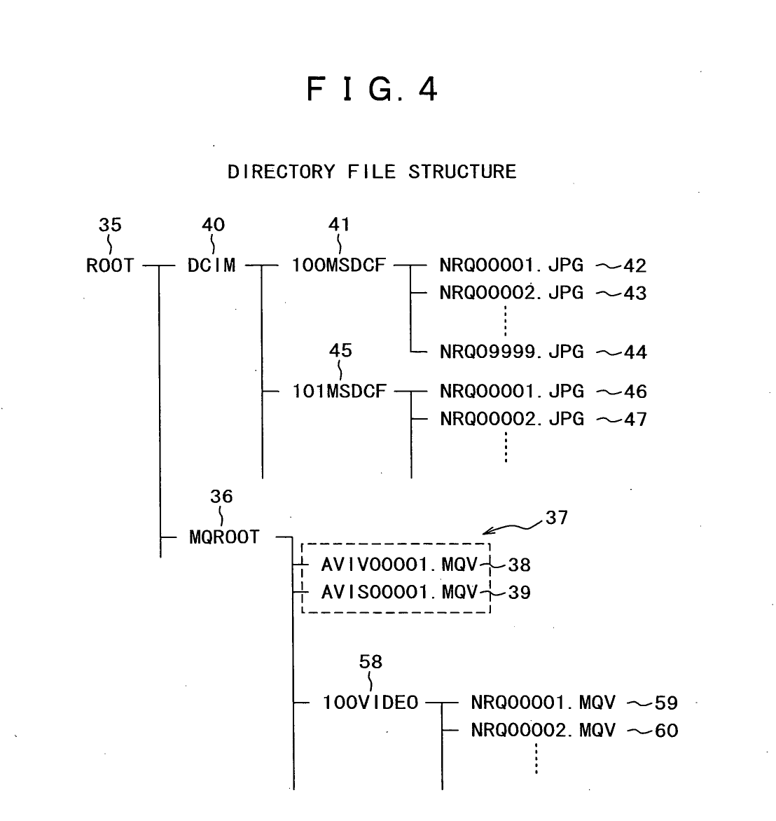

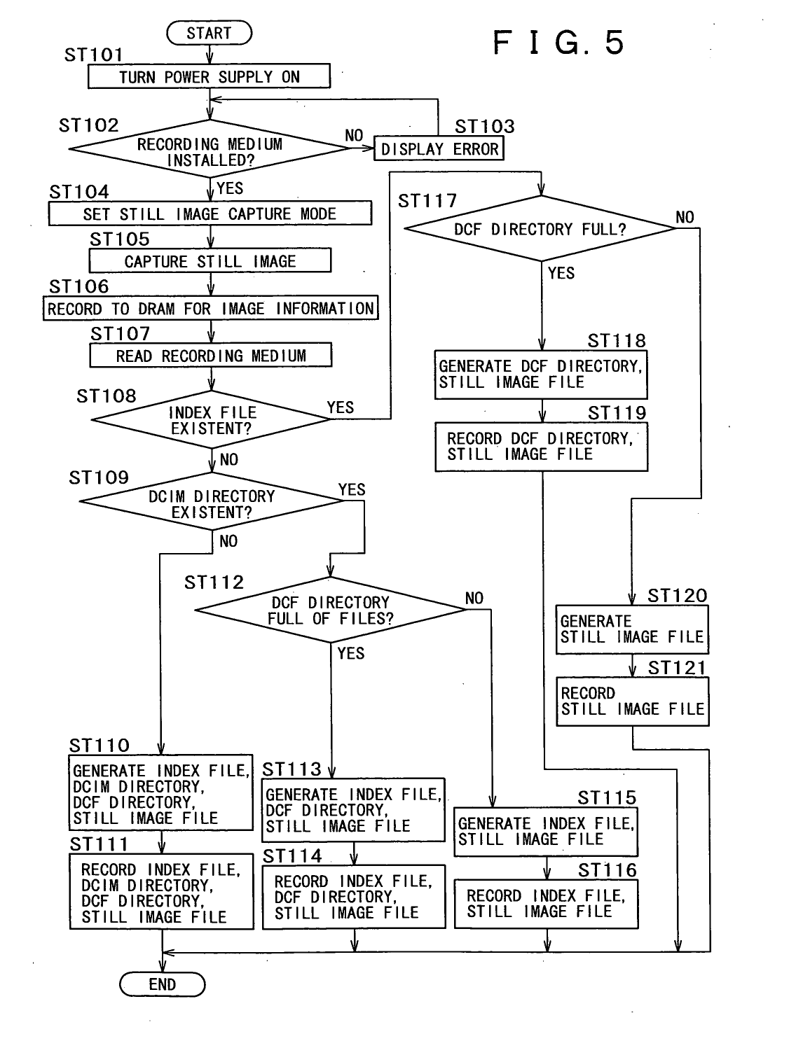

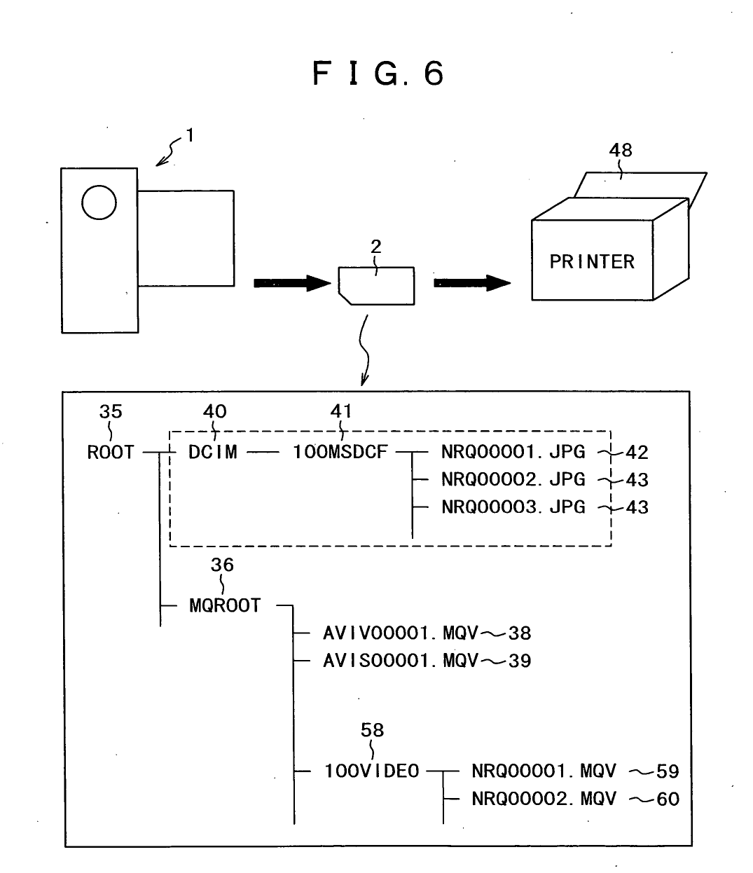

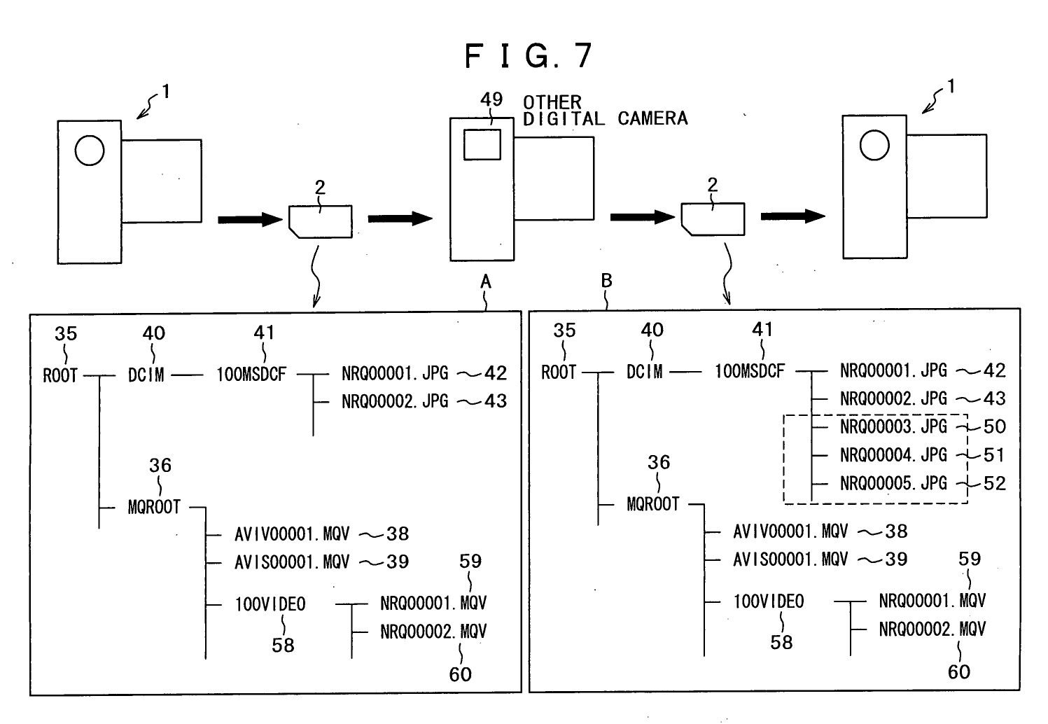

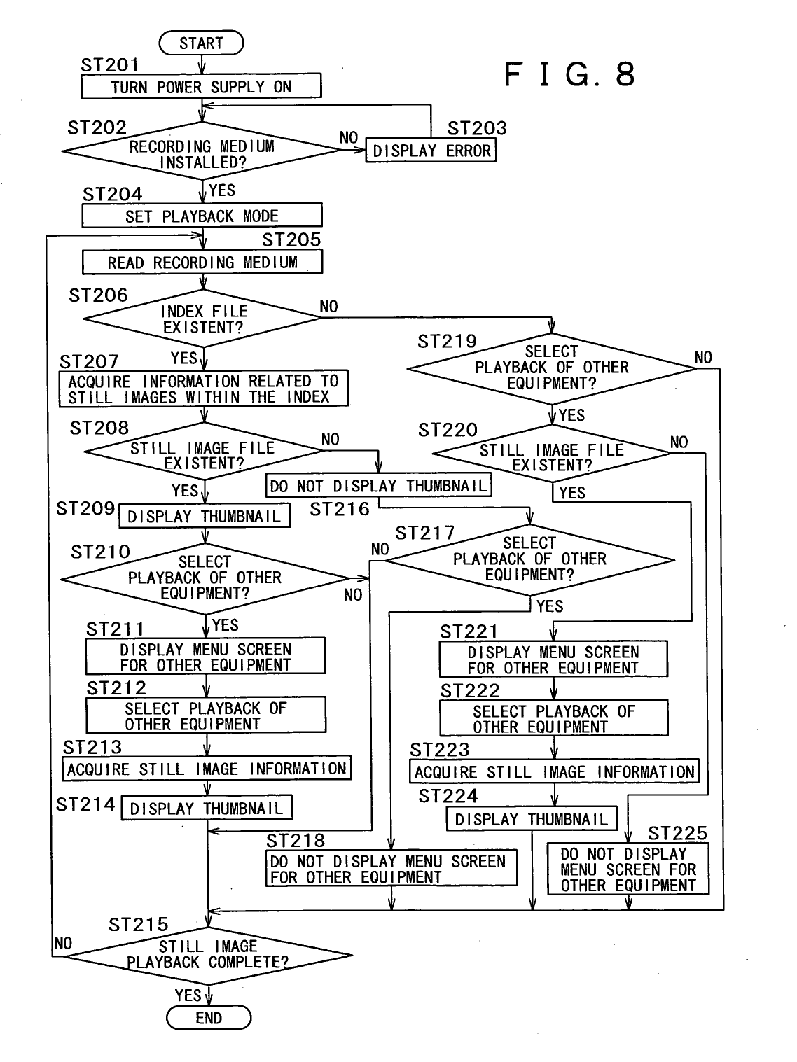

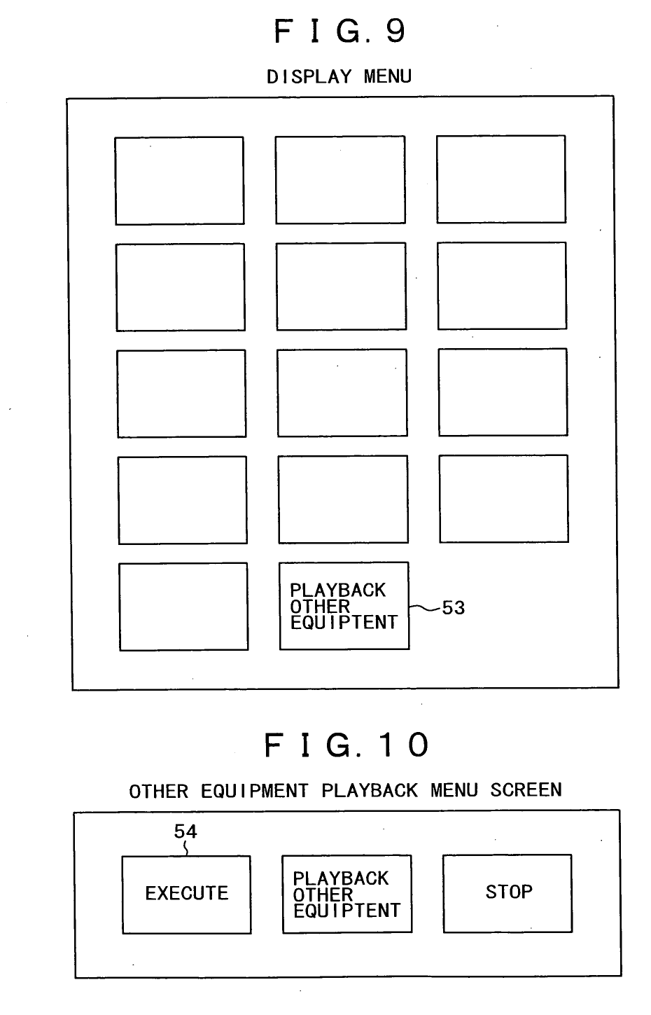

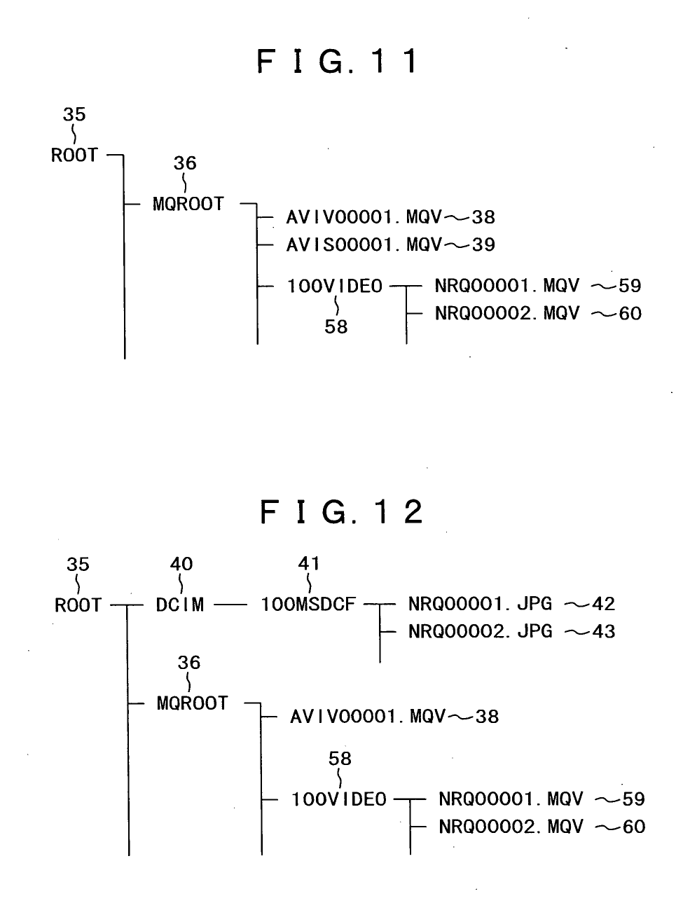

FIG. 1 is an outline perspective view from the operation side of a digital camera according to a first preferred embodiment of the present invention, FIG. 2 is an outline perspective view from imaging unit side of the digital camera, FIG. 3 is a block view centered about a control unit of the digital camera, FIG. 4 is a view illustrating a directory file structure generated by the digital camera, FIG. 5 is a flowchart for the case of recording image information on a recording medium, FIG. 6 is a view illustrating the case of reproducing on electronic apparatus using another standard after recording on a recording medium using the digital camera of the first preferred embodiment of the present invention, FIG. 7 is a view illustrating the case of recording on another recording medium using electronic apparatus employing another standard after recording on a recording medium using a digital camera of the first preferred embodiment of the present invention, FIG. 8 is a flowchart for the case of reproducing image information recorded on a recording medium, FIG. 9 is a view illustrating a menu screen for the digital camera of the first preferred embodiment of the present invention, FIG. 10 is a view illustrating a reproduction menu screen for another model of digital camera of the first preferred embodiment of the present invention, FIG. 11 is a view illustrating a directory structure where an actual file for a still image does not exist, and FIG. 12 is a view illustrating a directory structure where a still image index file does not exist but an actual file does exist.

The electronic apparatus shown in FIG. 1 and FIG. 2 is, for example, a digital camera 1, and a portable recording medium 2 is capable of being inserted into and removed from the digital camera 1.

Here, the portable recording medium 2 has a recording medium (hereinafter referred to simply as “recording medium”) employing, for example, flash memory as a recording element, and as shown in, for example, FIG. 1, FIG. 2, and FIG. 3, the digital camera 1 has a camera body 3 and a display unit 4 capable of being rotated so as to close into the side of the camera body 3.

Further, the camera body 3 is equipped with an input/output unit 5 for inputting and outputting operation information and image information, and sound information etc., an interface 6 for exchanging information with the recording medium 2 etc., and a control unit 7 for controlling overall operation of the digital camera 1 such as input and output of information and selection, etc.

Further, the input/output unit 5 includes an operation unit 8 for operating a digital camera as shown, in FIG. 3, for example, an imaging unit 9 for converting and processing electrical signals taken for a subject, and an audio unit 10 for carrying out conversion and processing of sound information and electrical signals.

Here, as shown, for example, in FIG. 1 and FIG. 2, the operation unit 8 is provided with a ring-type dial 11 provided at a side (back of the camera body) opposite to the front where the lens of the camera body 3 is provided, with an action button 12 being arranged at the center of the ring-type dial 11. The ring-type dial 11 is for selecting buttons etc. displayed at, for example, the display unit 4 as with a mouse, and the action button 12 is pressed down in, for example, two stages, and is capable of selecting PLAY and REC, and shutter, etc.

Further, for example, a mode dial 14, function button 15 arranged at the center of the mode dial 14 and power switch 16 are provided below the ring-type dial 11. Here, the mode dial 14 is for selecting a still image capture mode, moving image capture mode, and playback mode, etc. Moreover, the function button 15 is, for example, pushed in two stages so that MENU etc. can be selected, and the power switch 16 enables the power supply to be turned on, etc.

A zoom switch 17 etc. for the operation unit 8 is provided on the lens side of the camera body 3. The zoom switch 17 is used to zoom up to the subject or to switch over from a moving image displayed at the display screen of the display unit 4 to a still image, etc.

Further, the imaging unit 9 is equipped with, for example, a lens 18 for forming an image of a subject, a imaging element 19 (not shown) for changing an image from the lens 18 into an electrical signal, and an image processor for processing electrical signals from the imaging element 19. The imaging element 19 is, for example, a CCD (Charge Coupled Device), and can be configured from a multiplicity of light receiving elements.

The audio unit 10 has, for example, a microphone 20 for gathering and converting into an electrical signal sound etc. from outside and a speaker 21 for converting an electrical signal into sound etc.

The interface 6, for example, as shown in FIG. 2 and FIG. 3, connects the recording medium 2 etc. and the control unit 7 etc., and is provided with a memory slot 22 etc. enabling the recording medium 2 to be attached to and detached from the camera body 3.

Next, as shown, for example, in FIG. 3, the control unit 7 includes a CPU (Central Processing Unit) 23 for performing operations and control, a DRAM (Dynamic Random Access Memory) 24 recorded temporarily with image information, directory information, file information, a variety of data and software etc. as necessary for carrying out control of the digital camera 1 in a smoother manner, a ROM (Read Only Memory) 25 and a software storage unit 26 storing a variety of software.

Further, as shown, for example, in FIG. 3, an input information reading mechanism 27, imaging processing mechanism 28, directory/file generating mechanism 29, image display mechanism 30, recording information output mechanism 31, reproduction mechanism 32 and other types of apparatus reproduction mechanism 34 etc. are stored in the software storage unit 26.

The input information reading mechanism 27, under the control of the CPU 23, for example, reads information inputted via the interface 6, and is capable of handing over this information content, for example information such as directories and file structures recorded on the recording medium 2 and information relating to still images recorded in the files etc. to the directory/file generating mechanism 29, image display mechanism 30, reproduction mechanism 32 and other types of apparatus reproduction mechanism 34, etc.

The input information reading mechanism 27, under the control of the CPU 23, for example, reads in input information from the mode dial 14 of the operation unit 8 of the input/output unit 5 etc., and is capable of passing over selection information such as still image capture mode, moving image capture mode, and playback mode to the imaging processing mechanism 28, directory/file generating mechanism 29, image display mechanism 30, recording information output mechanism 31, reproduction mechanism 32 and another type of apparatus reproduction mechanism 34, etc.

Further, the imaging processing mechanism 28, under the control of the CPU 23, for example, is capable of passing over electrical signals from the imaging element 19 of the imaging unit 9 to the image display mechanism 30, compressing still images using, for example, JPEG (Joint Photographic Experts Group), and is capable of recording this compressed image information in temporary DRAM 24.

The directory/file generating mechanism 29, under the control of the CPU 23, for example, if compressed image information is read in from the DRAM 24, is capable of generating an MQ ROOT directory 36 constituting a sub-directory for providing an AVIndex file 37 taken as an index file for still image use etc. using a Quick Time (trademark) compatible format under the ROOT directory 35 shown in FIG. 4, with, for example, an AVIS00001.MQV39 constituting an index file for still image use being generated under.

Further, the MQ ROOT directory 36 is a directory mainly for saving MQT method moving images, still images, audio, and music content and the electronic apparatus of the present invention, for example, the digital camera 1, records actual moving image files and moving image indexes under this directory while recording and playing back moving image files. Further, the electronic apparatus of the present invention, for example, the digital camera 1, can mainly be made to access the MQ ROOT directory 36 at times other than for playing back or actual data for still images or another type of apparatus conversion mode.

Here, four types of data, for example, property, text, thumbnail, and intro can be accommodated in the index file. Property is data indicating attributes of each AV file (this refers to files where the file data is image data or audio data) and has information referring to actual data of AV files.

Further, the directory/file generating mechanism 29 generates a DCIM directory 40 in parallel with an MQ ROOT directory 36 under the ROOT directory 35 as shown, for example, in FIG. 4, under the control of the CPU 23.

The directory/file generating mechanism 29 is capable of generating a 100MSDCF directory 41 as a sub-directory under, for example, the DCIM directory 40 and generating NRQ00001.JPG42 as an actual file for the still image under this under the control of the CPU 23.

In other words, the directory/file generating mechanism 29 is first generating means for generating the MQ ROOT directory 36 as a first subdirectory relating an index file to a route directory under the route directory, and second generating means for generating a DCIM directory 40 as a second subdirectory relating the actual file to the route directory.

Further, the directory/file generating mechanism 29, under the control of the CPU 23, for example, is capable of reading information such as whether or not an index file etc. already exists in the recording medium 2 from the DRAM 24 and generating required directories and files corresponding to these recording conditions.

Here, the DCIM directory 40 etc. is based on a DCF (Design rule for Camera File system) design based on the image file format standard Exif described in the following and CIFE (Camera Image File Format) defining the structure of directories and files for recording and managing detachable memory efficiently. As a result, even for electronic apparatus compatible only with the conventional image file format standard Exif, it is made possible to reproduce still images, and still images can easily be reproduced even between electronic devices adopting different file formats.

Next, the image display mechanism 30, under the control of the CPU 23 is capable of displaying each of the operating conditions of the digital camera 1 and each selection button etc. based on information from the input information reading mechanism 27, in addition to being able to receive image information received from the imaging processing mechanism 28 and displaying this on the display unit 4.

Further, the image display mechanism 30, under the control of the CPU 23, for example, is capable of displaying image information etc. received from the reproduction mechanism 32 and recorded on the recording medium 2 as described later.

The recording information output mechanism 31, under the control of the CPU 23, for example, is capable of outputting and recording information such as directories and files etc. generated by the directory/file generating mechanism 29 as shown in FIG. 4 to the recording medium 2.

In other words, the recording information output mechanism 31 is recording means for recording the route directory, the MQ ROOT directory 36 constituting the first subdirectory, the index file, for example, AVIS00001.MQV39, the DCIM directory 40 constituting the second subdirectory, and the actual file, for example, NRQ00001.JPG42 on the recording medium 2.

Further, under the control of the CPU 23, for example, if information instructing reproduction from the operation unit 8 is transmissible by the input information reading mechanism 27, the reproduction mechanism 32 is capable of reading directories and files for still images etc. recorded in the recording medium 2 into the input information reading mechanism 27, and receiving actual data etc. for this still image. The reproduction mechanism 32 can then subject this information to required processing and pass the information over to the image display mechanism 30.

In other words, the input information reading mechanism 27 and reproduction mechanism 32 etc. are first reading means for reading an MQ ROOT directory 36 constituting a first subdirectory relating an index file, for example, AVIS00001.MQV39 to a ROOT directory 35 constituting a root directory.

Further, for example, if the other apparatus reproduction button is displayed on the image display mechanism 30 under the control of the CPU 23 at event of the menu screen, the other apparatus reproduction button is selected, and executed, the other types of apparatus reproduction mechanism 34 reads in actual files for all of the still images generated for the DCIM directory 40 and, for example, the 100MSDCF directory 41, and NRQ00001.JPG42 etc. directly without depending on the index file under the MQ ROOT directory 36, and is capable of delivering this to the image display mechanism 30 etc.

In this way, reproduction is made possible even for still images where there is no collation information at, for example, the property of the index file under the MQ ROOT directory 36.

In other words, the input information reading mechanism 27 and another type of apparatus reproduction mechanism 34 etc. are second reading means capable of reading the DCIM directory 40 constituting the second subdirectory generated under the ROOT directory 35 in parallel with the MQ ROOT directory 36.

The display unit 4 may employ, for example, a color liquid crystal display device for displaying imaging information etc., and the display screen 13 of the liquid crystal panel of this color liquid crystal display device is formed on one side of the display unit 4 as shown in FIG. 1.

Next, a simple description is given of a directory file structure (hereafter referred to as “directory structure”) of FIG. 4.

The directory structure is a tree-shaped structure taking the ROOT directory 35 as an apex, as shown, for example, in FIG. 4, with the MQ ROOT directory 36 being provided under the root directory 35 to enable use as a Quick Time application format index file. Still below, a AVIndex file 37 is provided having, for example, AVIV00001.MQV38 constituting a moving image index file and AVIS00001.MQV39 constituting a still image index file in parallel.

Further, a 100VIDEO directory 58 is then provided at the AVIV00001.MQV38 constituting a moving image index file as a subdirectory in parallel with the AVIV00001.MQV38 shown, for example, in FIG. 4, under which are provided, for example, NRQ00001.MQV59 and NRQ00002.MQV60 etc. as actual files for moving images.

Further, the DCIM directory 40 is provided in parallel with the MQ ROOT directory 36 under the root directory 35. The DCIM directory 40 is a directory reproducible by an electronic apparatus compatible with DCF, and under this directory, a 100MSDCF directory 41 is provided, for example, as a subdirectory.

Further, the 100MSDCF directory 41 taken as a subdirectory name is generated based on DCF, with the leading three characters being numbers 100 to 999 that do not overlap, and with the remaining five characters being freely selectable to be provided for use. In the case where an image storage directory (hereinafter referred to as a “DCF directory”) is additionally generated below the DCIM directory 40 generated according to rules relating to the DCF directory, as shown in the 101 MSDCF directory 45 shown in FIG. 4, it is preferable for the directory number to be a number running consecutively from the maximum number of an existing directory +1.

Further, for example, NRQ00001.JPG can be provided as a file under the 100MSDCF directory 41.

Here, for example, NRQ00001.JPG taken as a file name is such that the leading four characters can be freely selected from characters decided by the DCF, the subsequent four digits are a file number, with the following then describing an extension.

Further, recording is made possible up to a maximum of 9999 items with file groups (DCF objects) recorded according to rules decided by the file number, and numbers may also be omitted.

Further, the extension JPG indicates that, for example, the file of file name NRQ0001.JPG is still image information compressed using the JPEG format. In addition, it is also possible to indicate the presence of a still image emotion file by using “EMO” as an extension. As a result of this, it is made possible to configure a DCF object from two files for which only the extensions are different using “JPG” and “EMO”.

Next, a brief description is given of AVIS00001.MQV39 constituting an index file.

AVIS00001.MQV39 is provided as a still image index file under the MQ ROOT directory 36.

The AVIS00001.MQV39 stores data such as property, text, and thumbnails etc., with property being data expressing attributes of each AV file, and also have information referring to actual data for an AV file, such as, such as NRQ00001.JPG42, etc.

Further, text is data showing a character string for a title for each AV file, and a thumbnail is simplified image data that makes typical image data for each AV file smaller by thinning out pixels etc.

AVIS00001.MQV39 specifically has, for example, an index atom and an index data atom. A movie header atom, track atom (property), track atom (text) and track atom (thumbnail) etc. are provided at the index atom.

Here, information for data length and start byte position is stored at, for example, AV file property #1 corresponding to each entry number for the index data item at the track item (property), and is information for managing the property of index data atoms constituting actual data.

Further, property, text, and thumbnails etc. are stored for each entry number at the index data atom, with the property having entry management information and file attribute information.

Here, the entry management information is information for managing entries themselves, and has an entry number and entry property etc. The entry property shows attributes and states of entries.

Further, the file attribute information is configured from, for example, version, flags, data type, generation time, file identifier (binary file identifier), referring file list, and URL file identifier, etc.

Version is the file version number recorded in the entry, and flags are for identifying file attributes.

Further, the data type indicates the AV file data type, for example, still image etc., and the file identifier is binary data indicating the location of files relating to the property.

Further, the referring file list is written with an ID indicating the entry number or the location of the actual file, and the URL file identifier is URL format data indicating the location of the file.

Next, a description is given of the operation of the digital camera 1 configured in the above manner.

First, a description is given of the case of recording image information to the recording medium 2. The MQ ROOT directory 36 is a directory mainly for saving MQT method moving images, still images, audio, and music content and the electronic apparatus of the present invention, for example, the digital camera 1, records actual moving image files and moving image indexes under this directory while recording and playing back moving image files. In the case where image information is recording to the recording medium 2, a description is given where, for example, AVIV00001.MQV38, 100VIDEO directory 58 constituting its subdirectory, and NRQ00001.MQV59 constituting an actual file are generated for an existing moving image index file as shown in FIG. 4 and FIG. 6.

As shown in FIG. 5, if the recording medium 2 is installed into the memory slot 22 of the digital camera 1 and the power supply is turned on using the power switch 16, in step ST101, the CPU 23 determines whether or not the recording medium 2 is installed in the memory slot 22 at the input information reading mechanism 27, in step ST102. If it is determined that the input information reading mechanism 27 is not installed at the memory slot 22, the CPU 23 displays an error at the image display mechanism 30, in step ST103.

Further, if information for which still image capture mode has been selected by the mode dial 14 is received from the input information reading mechanism 27, the CPU 23 displays a image recording standby image at the image display mechanism 30. In this event, it is made possible to set the image size and file number, etc.

The CPU 23 then sets still image capture mode etc., in step ST104, and, for example, information that the action button 12 is pressed all the way down is transmitted from the input information reading mechanism 27, this information is delivered to the imaging unit 9, and a still image is captured, in step ST105.

The CPU 23 then subjects electrical signals from the imaging unit 9 to necessary processing such as, for example, JPEG image compression at the imaging processing mechanism 28, and this image information is recorded temporarily in DRAM 24, in step ST106.

Next, the CPU 23 reads the recorded information of the recording medium 2 into the input information reading mechanism 27, in step ST107 and this read information is delivered to the directory/file generating mechanism 29. The CPU 23 then determines whether or not a still image index file, for example, AVIS00001.MQV39 shown in FIG. 4 and FIG. 6, is present in the directory/file generating mechanism 29, in step ST108.

If it is determined that, for example, AVIS00001.MQV39 does not exist for the directory/file generating mechanism 29, the CPU 23 makes a further determination as to whether or not a DCIM directory 40 is present in the directory/file generating mechanism 29, in step ST109.

Here, if it is determined that there is no DCIM directory 40 for the directory/file generating mechanism 29, then there is as yet no actual file for a still image at the recording medium 2. Recording regions are then ensured for files of the names of AVIS00001.MQV39 taken as an index file and DCIM directory 40, for example, 100MSDCF directory 41 taken as a first DCF directory, and, for example, NRQ00001.JPG42 taken as an actual file for a still image at the directory/file generating mechanism 29, the recording position is decided, and the directories and files are generated, in step ST110.

In this event, reference information relating to a DCIM directory 40, for example 100MS DCF directory 41, is stored as the property of AVIS00001.MQV39 and, for example, reference information relating to NRQ00001.JPG42 is stored as an actual file for a still image. In this way, it is made possible to utilize an enhanced speed search function using the index file, reading of an actual file, for example, NRQ00001.JPG42, using, for example, the conventional Exif standard is made possible, and straightforward interchangeability between file formats is made possible at reduced cost.

Further, the CPU 23 then outputs and records information for directories and files generated by the directory/file generating mechanism 29 to the recording medium 2 using the recording information output mechanism 31, in step ST111.

It is also possible to record to the recording medium 2 by recording at appropriate times at fixed periods, for example, directly before extracting the recording medium 2 from the memory slot 22.

Next, if it is determined at the directory/file generating mechanism 29 in ST109 that a DCIM directory 40 is present, the CPU makes a determination at the directory/file generating mechanism 29 as to whether or not the DCF directory file is full, in step ST112.

Whether or not the file of the DCF directory is full is to determine whether or not a file number for an actual file under the DCF directory for which the directory number of the DCF directory is the largest, for example, NRQ09999.JPG44 as shown in FIG. 4, is 9999.

If the directory/file generating mechanism 29 determines that the file number has reached 9999, the CPU 23 determines whether or not the file for the DCF directory is full at the directory/file generating mechanism 29.

Next, the CPU 23 reserves recording regions at the directory/file generating mechanism 29 for files of names of, for example, AVIS00001.MQV39 taken as an index file and, for example, 101MSDCF directory 45 taken as the next DCF directory, and, for example, NRQ00001.JPG46 taken as the actual file for the still image below the DCF directory, decides upon recording positions, and generates the directories and files, in step ST113.

In this event, collation information relating to, for example, 101MSDCF directory 45, and, for example, NRQ00001.JPG46 taken as an actual file for a still image is stored at the property of AVIS00001.MQV39. In this way, it is made possible to utilize an enhanced speed search function using the index file, reading of an actual file, for example, NRQ00001.JPG46, using, for example, the conventional Exif standard is made possible, and straightforward interchangeability between file formats is made possible to realize at reduced cost.

Further, the CPU 23 then outputs and records information for directories and files generated by the directory/file generating mechanism 29 to the recording medium 2 using the recording information output mechanism 31, in step ST114.

Next, if it is determined in ST112 that the file for the DCF directory at the directory/file generating mechanism 29 is not full, the CPU 23 reserves recording regions for files of the names of, for example, AVIS00001.MQB39 taken as an index, and NRQ00002.JPG47 giving a file number +1 for the actual file for the still image under, for example, 101MSDCF directory 45 for the DCF directory for this at the directory/file generating mechanism 29, decides the recording position, and generates the files, in step ST115.

In this event, collation information relating to, for example, NRQ00002.JPG47 taken as, for example, an actual file for a still image is stored at the property of AVIS00001.MQV39. In this way, it is made possible to utilize an enhanced speed search function using the index file, reading of an actual file, for example, NRQ00002.JPG47, using, for example, the conventional Exif standard is made possible, and straightforward interchangeability between file formats is made possible to realize at reduced cost.

Further, the CPU 23 then outputs and records information for directories and files generated by the file generating mechanism 29 to the recording medium 2 using the recording information output mechanism 31, in step ST116.

Next, if the CPU 23 determines in ST108 that an index file is present at the directory/file generating mechanism 29, in principle a DCIM directory 40 and a subdirectory thereof also exist, and a determination is therefore made as to whether or not the file for the DCF directory is full at the directory/file generating mechanism 29, in step ST117.

Here, if it is determined in ST117 that the file of the DCF directory is full at the directory/file generating mechanism 29, the CPU 23 reserves recording regions for files of the names of 101MSDCF directory 45 as shown, for example, in FIG. 4 taken as the next DCF directory, and, for example, NRQ00001.JPG46 taken as an actual file for a still image under the DCF directory of the largest DCF directory number, decides the recording positions, and generated directories and files, in step ST118.

During this time, collation information relating to, for example, 101MSDCF directory 45, and, for example, NRQ00001.JPG46 taken as an actual file for a still image is stored at the property of AVIS00001.MQV39. In this way, it is made possible to utilize an enhanced speed search function using the index file, reading of an actual file, for example, NRQ00001.JPG46, using, for example, the conventional Exif standard is made possible, and straightforward interchangeability between file formats is made possible to realize at reduced cost.

Further, the CPU 23 then outputs and record information for directories and files generated by the directory/file generating mechanism 29 to the recording medium 2 using the recording information output mechanism 31, in step ST119.

Next, if it is determined in ST117 that the file for the DCF directory at the directory/file generating mechanism 29 is not full, the CPU 23 reserves a recording region for a file of the name of, for example, NRQ00002.JPG47 giving a file number +1 for the actual file for the still image under, for example, 101MSDCF directory 45 for the DCF directory for which the directory number is the largest, decides the recording position, and generates the files, in step ST120.

In this case also, collation information relating to, for example, NRQ00002.JPG47 is stored at the property of AVIS00001.MQV39.

Further, the CPU 23 then outputs and records information for directories and files generated by the file generating mechanism 29 to the recording medium 2 using the recording information output mechanism 31, in step ST121.

If only the actual file for the still image does not exist at all as a result of deletion of the file etc., a recording region for a file of the name of file number 0001, for example, NRQ00001.JPG42 is ensured, a recording position is decided, and the file is generated, in step ST120.

If the DCIM directory 40 and the DCF directory do not exist (for example, in the case of the directory structure as shown in FIG. 11), recording regions of names of DCIM directory 40 and the DCF directory of the smallest directory number, for example, 100MSDCF directory 41 and file number 0001, for example, NRQ00001.JPG42 are ensured, recording position is decided, and directories and files are generated.

Further, the CPU 23 then outputs and records information for directories and files generated by the directory/file generating mechanism 29 to the recording medium 2 using the recording information output mechanism 31.

As a result of the above, the operation in the case where image information is recorded on the recording medium 2 using a digital camera 1 is complete.

As a result, actual files for still images are always generated under a DCIM directory 40 based on the Exif standard so that, for example, if a still image is captured using a digital camera, the directory structure surrounded by a frame as shown in FIG. 6 is generated and recorded on the recording medium 2.

Therefore, even if this recording medium 2 is installed in a printer 48 based only on the Exif standard, for example, it is made possible to reproduce all subdirectories and actual files below the DCIM directory 40 surrounded by the dotted line in FIG. 6.

Next, a description is given of the operation in the case of reproducing image information recorded on the recording medium 2.

Further, the MQ ROOT directory 36 is a directory mainly for saving MQT method moving images, still images, audio, and music content and the electronic apparatus of the present invention, for example, the digital camera 1, records actual moving image files and moving image indexes under this directory while recording and playing back moving image files. In the case of playing back image information recorded on the recording medium 2 described in the following, a description is given where, for example, AVIV00001.MQV38, 100VIDEO directory 58 constituting its subdirectory, and NRQ00001.MQV59 constituting an actual file are recorded for an existing moving image index file as shown in FIG. 7.

Here, a description is given of the case where, as shown, for example, in FIG. 7, first, the directory structure surrounded by a frame A is recorded on the digital camera 1, after which the recording medium 2 recorded with files surrounded by the dotted lines within frame B for another digital camera 49 not compatible with the MQ ROOT directory 36 is reproduced by the digital camera 1.

As shown in FIG. 8, if the recording medium 2 is installed into the memory slot 22 of the digital camera 1 and the power supply is turned on using the power switch 16, in step ST201, the CPU 23 determines whether or not the recording medium 2 is installed in the memory slot 22 at the input information reading mechanism 27, in step ST202. If it is determined that the input information reading mechanism 27 is not installed at the memory slot 22, the CPU 23 displays an error at the image display mechanism 30, in step ST203.

If the CPU 23 transmits information that, for example, the still image playback mode setting has taken place using the mode dial 14 etc., in step ST204, from the input information reading mechanism 27, the recording medium 2 is read by the input information reading mechanism 27, in step ST205, and this read information is delivered to the reproduction mechanism 32.

Here, the CPU 23 first determines whether or not an index file for a still image, for example, AVIS00001.MQV39 shown in FIG. 7, is present in the reproduction mechanism 32, in step ST206.

If it is determined that, for example, AVIS00001.MQV39 is present in the reproduction mechanism 32, the CPU 23 acquires information relating to the still image such as, for example, property, text, and thumbnail etc. stored each entry number in the information content for this index file, in step ST207.

The CPU 23 then determines whether or not at least one actual file for a still image, such as NRQ00001.JPG42, etc. is present using information related to the still image acquired in ST207 at the reproduction mechanism 32, such as information referring to actual data for the property AV file, in step ST208.

Further, for example, determining whether or not a file with an extension JPG is present is made possible as a method of determining whether or not at least one actual file for a still image, such as NRQ00001.JPG42 exists.

Moreover, if it is determined that at least one actual file for a still image, for example, NRQ00001.JPG42 is present at the reproduction mechanism 32, the CPU 23 reads, for example, up to NRQ00001.JPG42 constituting an actual file for the still image via the DCIM directory 40 and the 100MSDCF directory under the DCIM directory 40 shown in FIG. 7 using information relating to the still image acquired in ST207, such as information referring to actual data for the AV file for property, and it is then possible to acquire still image information specified by information on the index file.

In this way, first, a desired still image is searched at considerably enhanced speed from information on the index file.

Next, the CPU 23, for example, delivers information for a thumbnail for the still image acquired at the reproduction mechanism 32 to the image display mechanism 30 together with other image information as a single item of image information.

As a result, image information such as a thumbnail for the still image specified by the index of AVIS00001.MQV39, for example, can be displayed on the display screen 13 of the display unit 4, in step ST204. In this event, for example, still image information for actual files for still images captured by another digital camera 49 not specified by the property of AVIS00001.MQV39, for example, the files of NRQ00003.JPG50 to NRQ00005.JPG52 surrounded by the dotted line in FIG. 7 cannot be transmitted to the image display mechanism 30, and displaying as thumbnails at the display screen 13 is not possible.

On the other hand, it is considered that the user looking at the display screen 13 wishes to display still images captured and recorded by the other digital camera 49, so that, for example, if the function button 15 is pushed down halfway, the CPU 23 transmits this operation information to the input information reading mechanism 27, and at the input information reading mechanism 27, this input information can be transmitted to the image display mechanism 30. Further, the CPU 23 then displays a menu screen such as, for example, that shown in FIG. 9, at the image display mechanism 30 receiving this input information.

Here, the CPU 23 determines whether or not another type of apparatus reproduction button 53 displayed at the menu screen by the other types of apparatus reproduction mechanism 34 has been selected, in step ST210.

For example, if input information that the other types of apparatus reproduction button 53 on the menu screen has been selected is received by the input information reading mechanism 27 from the operation unit 8, at the input information reading mechanism 27, the CPU 23 delivers this information over to the other types of apparatus reproduction mechanism 34. In this way, the CPU 23 determines whether or not the other types of apparatus reproduction button 53 have been selected by the other types of apparatus reproduction mechanism 34.

If it is determined at the other types of apparatus reproduction mechanism 34 that the other types of apparatus reproduction button 53 has been selected, the CPU 23 displays an other types of apparatus reproduction menu screen shown in FIG. 10 at the display unit 4 using the image display mechanism 30 at the other types of apparatus reproduction mechanism 34, in step ST211.

If the user selects, for example, the other types of apparatus reproduction execution button 54 of the other types of apparatus reproduction menu screen, in step ST212, this selection information is inputted to the input information reading mechanism 27 from the operation unit 8, and the input information reading mechanism 27 sends this selection information to the other types of apparatus reproduction mechanism 34.

If the other types of apparatus reproduction mechanism 34 receives information that the other types of apparatus reproduction execution button 54 is selected, the CPU 23 plays back NRQ00001.JPG42 and NRQ00003.JPG50, etc. shown in FIG. 7 constituting the actual files for the still image based on the conventional Exif standard, for example, at the other types of apparatus reproduction mechanism 34.

For example, the CPU 23 reads out the DCIM directory 40 under the ROOT directory 35 at the other types of apparatus reproduction mechanism 34 so as to acquire information within the DCIM directory 40, and reads out the 100MSDCF director 41 lower down based on this acquired information. Similarly in the following, reading out takes place up to, for example, NRQ00001.JPG42 constituting the actual file for the still image, so as to make it possible to acquire this still image information. Further, similarly, reading out takes place up to, for example, NRQ00005.JPG52 constituting the actual file for the still image, so as to make it possible to acquire all of this still image information, in step ST213.

The CPU 23, for example, delivers information for a thumbnail accompanying the image information for the still image acquired at the other types of apparatus reproduction mechanism 34 to the image display mechanism 30 together with other information as a single item of image information.

As a result, thumbnails etc. for the still images are displayed at the display screen 13 of the display unit 4 regardless of the index of AVIS00001.MQV39, for example, in step ST214, and it is therefore also possible to play back the actual files NRQ00003.JPG50, etc. for the still images surrounded by the dotted line shown in FIG. 7 taken and recorded using another digital camera 49 not compatible with the index file AVIS00001.MQV39, for example.

It is also possible for the CPU 23 to generate thumbnail information at the other types of apparatus reproduction mechanism 34 if there is no thumbnail information accompanying the still image information acquired at the other types of apparatus reproduction mechanism 34 in ST213.

Further, it is also possible for the CPU 23 to determine whether or not reproduction of still images is complete according to whether input information that still image reproduction is complete has been transmitted to the input information reading mechanism 27 from, for example, the operation unit 8 at the other types of apparatus reproduction mechanism 34, or whether nothing has been transmitted from the operation unit 8 to the input information reading mechanism 27 for a prescribed time, in step ST215.

If input information that the other types of apparatus reproduction button 53 on the menu screen has not been selected in ST210 is received by the input information reading mechanism 27 from the operation unit 8, at the input information reading mechanism 27, the CPU 23 delivers this information over to the other types of apparatus reproduction mechanism 34. In this way, the CPU 23 determines whether or not the other type of apparatus reproduction button 53 has not been selected by the other types of apparatus reproduction mechanism 34.

If it is determined that the other types of apparatus reproduction button 53 is not selected at the other types of apparatus reproduction mechanism 34, the CPU 23 advances beyond ST214, and determines whether or not reproduction of the still image is complete.

Further, if the CPU 23 determines in ST215 that reproduction of the still image at the other types of apparatus reproduction mechanism 34 is complete, operation for the case of reproduction of the image information recorded on the recording medium 2 is complete.

With respect to this aspect, if it is determined in ST215 that input information causing searching and displaying of a desired still image is present at the input information reading mechanism 27 from the operation unit 8 again using, for example, the index file, determination of the completion of reproduction of the still image at the other types of apparatus reproduction mechanism 34 is not performed, prior to ST205 is returned to again, and reading of the recording medium 2 is started.

Next, in ST208, if the reproduction mechanism 32 determines that there is not one actual file for a still image, such as NRQ00001.JPG42, etc. (for example, in the case of the directory structure shown in FIG. 11), a still image thumbnail is not displayed at the display screen 13, in step ST216.

In addition to the presence or absence of a file with an extension JPG, it is also possible to determine at the reproduction mechanism 32 the presence or absence of an actual file for a still image by storing information that an actual file for a still image does not exist, for example, in a flag constituting file attribute information for property. In this way, it is made possible to rapidly determine the presence of actual files for still images using index file information.

On the other hand, it is considered that the user looking at the display screen 13 has still images captured and recorded by the other digital camera 49, so that if the function button 15 is pushed down halfway, the CPU 23 transmits this operation information to the input information reading mechanism 27, and at the input information reading mechanism 27, this input information can be transmitted to the image display mechanism 30. Further, the CPU 23 then displays a menu screen such as, for example, that shown in FIG. 9, at the image display mechanism 30 receiving this input information.

Here, the CPU 23 determines whether or not another types of apparatus reproduction button 53 displayed at the menu screen by the other types of apparatus reproduction mechanism 34 has been selected, in step ST217.

For example, if input information that the other types of apparatus reproduction button 53 on the menu screen has been selected is received by the input information reading mechanism 27 from the operation unit 8, at the input information reading mechanism 27, the CPU 23 delivers this information over to the other types of apparatus reproduction mechanism 34. In this way, the CPU 23 determines whether or not the other types of apparatus reproduction button 53 have been selected by the other types of apparatus reproduction mechanism 34.

The CPU 23 then ensures, for example, that the other types of apparatus reproduction menu screen as shown in FIG. 10 is not displayed at the image display mechanism 30 at the other types of apparatus reproduction mechanism 34, in step ST218. As a result, the user looking at the display screen 13 is made aware that there is not one actual file for a still image recorded and therefore does not proceed with any operations that may prove worthless thereafter.

Moreover, at the other types of apparatus reproduction mechanism 34, the CPU 23 sends this information to the image display mechanism 30, and may then display a message to the effect of, for example, “there is no still image file”. As a result, the user looking at the display screen 13 can recognize the state of the digital camera 1 in a more reliable manner.

If it is determined in ST218 that the other types of apparatus reproduction is not displayed at the other types of apparatus reproduction mechanism 34, the CPU 23 advances beyond ST214, and determines whether or not reproduction of the still image is complete.

If input information that the other types of apparatus reproduction button 53 on the menu screen has not been selected in ST217 is received by the input information reading mechanism 27 from the operation unit 8, at the input information reading mechanism 27, the CPU 23 delivers this information over to the other types of apparatus reproduction mechanism 34. In this way, the CPU 23 determines whether or not the other types of apparatus reproduction button 53 have not been selected by the other types of apparatus reproduction mechanism 34.

If it is determined that the other types of apparatus reproduction button 53 is not selected at the other types of apparatus reproduction mechanism 34, the CPU 23 advances beyond ST214, and determines whether or not reproduction of the still image is complete.

If it is determined in ST206 that, for example, AVIS00001.MQV39 constituting an index file does not exist for the reproduction mechanism 32, at the reproduction mechanism 32, the CPU 23 transmits this information to the image display mechanism 30, and a message saying that, for example, “there is no still image file” may be displayed.

Here, it is considered that the user looking at the display screen 13 wishes to display still images captured and recorded by the other digital camera 49, so that, for example, if the function button 15 is pushed down halfway, the CPU 23 transmits this operation information to the input information reading mechanism 27, and at the input information reading mechanism 27, this input information can be transmitted to the image display mechanism 30. Further, the CPU 23 then displays a menu screen such as, for example, that shown in FIG. 9, at the image display mechanism 30 receiving this input information.

The CPU 23 then determines whether or not other types of apparatus reproduction button 53 displayed at the menu screen by the other types of apparatus reproduction mechanism 34 has been selected, in step ST219.

For example, if input information that the other types of apparatus reproduction button 53 on the menu screen has been selected is received by the input information reading mechanism 27 from the operation unit 8, at the input information reading mechanism 27, the CPU 23 delivers this information over to the other types of apparatus reproduction mechanism 34. In this way, the CPU 23 determines whether or not the other types of apparatus reproduction button 53 have been selected by the other types of apparatus reproduction mechanism 34.

Further, if it is determined that the other types of apparatus reproduction button 53 is selected at the other types of apparatus reproduction mechanism 34, the CPU 23 determines whether or not an actual file for a still image, such as NRQ00001.JPG42, etc. is present under the DCIM directory 40 at the other types of apparatus reproduction mechanism 34, in step ST220.

If it is determined that at least one actual file for a still image is present at the other types of apparatus reproduction mechanism 34 from the presence or absence etc. of, for example, the extension JPG (for example, as with the directory structure shown in FIG. 12), the CPU 23 displays the other types of apparatus reproduction menu screen at the display unit 4 using the image display mechanism 30 at the other types of apparatus reproduction mechanism 34, in step ST221.

If the user selects, for example, the other types of apparatus reproduction execution button 54 of the other types of apparatus reproduction menu screen, in step ST222, this selection information is inputted to the input information reading mechanism 27 from the operation unit 8, and the input information reading mechanism 27 sends this selection information to the other types of apparatus reproduction mechanism 34.

If the other types of apparatus reproduction mechanism 34 receives information that the other types of apparatus reproduction execution button 54 is selected, the CPU 23 acquires still image information such as, such as NRQ00001.JPG42, etc. shown in FIG. 12 constituting the actual files for the still image based on the conventional Exif standard at the other types of apparatus reproduction mechanism 34, in step ST223.

The CPU 23, for example, delivers information for a thumbnail accompanying the image information for the still image acquired at the other types of apparatus reproduction mechanism 34 to the image display mechanism 30 together with other information as a single item of image information.

As a result, thumbnails etc. for the still images are displayed at the display screen 13 of the display unit 4 regardless of the index of AVIS00001.MQV39, for example, in step ST224, and reproduction is therefore also possible for actual files of NRQ00001.JPG42 etc., for still images of file structures where still image index files as shown in FIG. 12 such as, for example, AVIS00001.MQV39, do not exist.

It is also possible in ST223 for the CPU 23 to generate thumbnail information at the other types of apparatus reproduction mechanism 34 if there is no thumbnail information accompanying the still image information acquired at the other types of apparatus reproduction mechanism 34.

Further, after the still image thumbnail is displayed at the image display mechanism 30 in ST224, the CPU 23 advances to ST215, and a determination is made as to whether or not reproduction of the still image is complete at the other types of apparatus reproduction mechanism 34.

Next, if it is determined in ST220 that there is not one actual file for a still image at the other types of apparatus reproduction mechanism 34, the CPU 23 does not display, for example, the kind of other types of apparatus reproduction menu screen shown in FIG. 10 at the image display mechanism 30 at the other types of apparatus reproduction mechanism 34, in step ST225. As a result, the user looking at the display screen 13 is made aware that there is not one actual file for a still image recorded and therefore does not proceed with any operations that may prove worthless thereafter.

Moreover, at the other types of apparatus reproduction mechanism 34, the CPU 23 sends this information to the image display mechanism 30, and may then display a message to the effect of, for example, “there is no still image file”. As a result, the user looking at the display screen 13 can recognize the state of the digital camera 1 in a more reliable manner.

If it is determined in ST225 that the other types of apparatus reproduction is not displayed at the other types of apparatus reproduction mechanism 34, the CPU 23 advances beyond ST214, and determines whether or not reproduction of the still image is complete.

If input information that the other types of apparatus reproduction button 53 on the menu screen has not been selected in ST219 is received by the input information reading mechanism 27 from the operation unit 8, at the input information reading mechanism 27, the CPU 23 delivers this information over to the other types of apparatus reproduction mechanism 34. In this way, the CPU 23 determines whether or not the other types of apparatus reproduction button 53 have not been selected by the other types of apparatus reproduction mechanism 34.

If it is determined that the other types of apparatus reproduction button 53 are not selected at the other types of apparatus reproduction mechanism 34, the CPU 23 advances beyond ST214, and determines whether or not reproduction of the still image is complete.

Further, if the CPU 23 determines in ST215 that reproduction of the still image at the other types of apparatus reproduction mechanism 34 is complete, operation for the case of reproduction of the image information recorded on the recording medium 2 using the digital camera 1 is complete.

According to this embodiment, a digital camera 1 constituting an electronic apparatus related to an example of preferred embodiment of the present invention is provided with a directory file generating mechanism 29 for generating MQ ROOT directory 36 for relating an index file, for example, AVIS0001.MQV39, for input information under a root directory, and a directory file generating mechanism 29 for generating DCIM directory 40 for relating at least part of an actual file NRQ00001.JPG, for example, for input information in parallel with this MQ ROOT directory 36. It is therefore possible to read out actual files using, for example, a conventional Exif standard while providing an enhanced speed search function using AVIS00001.MQV39 constituting the index file even if separate files for interchanging are not generated, and interchanging between different file formats can therefore be achieved in a straightforward manner at reduced cost.

Further, the digital cameral 1 constituting an electronic apparatus related to an example of preferred embodiment of the present invention is provided with a recording information output mechanism 31 for recording, for example, at least a ROOT directory 35, an MQ ROOT directory 36 and AVIS00001.MQV39 generated by the directory/file generating mechanism 29, and a DCIM directory 40 generated by the directory/file generating mechanism 29 and actual file, for example, NRQ00001.JPG for a still image on a portable recording medium. It is therefore possible to provide a directory structure capable of reading in actual files for still images using, for example, a conventional Exif standard while providing a enhanced speed search function using an index file, and it is made possible to record and save image information to a portable recording medium such as, for example, a memory card etc. As a result, image information, etc. can be inputted to other electronic apparatus from this recording medium, at least an actual file employing, for example, an Exif standard for this image information can be acquired using this electronic apparatus, and interchangeability is increased.

The digital camera 1 constituting an electronic apparatus related to an example of preferred embodiment of the present invention includes, for example, an input information reading mechanism 27 and reproduction mechanism 32 etc. for reading an MQ ROOT directory 36 generated so as to relate an index, for example, AVIS00001.MQV39 for input information under a root directory 35, an input information reading mechanism 27 for reading a DCIM directory 40 generated by relating at least part of an actual file, for example, NRQ00001.JPG for input information in parallel with this MQ ROOT directory 36, and an other types of apparatus reproduction mechanism 34. It is therefore possible to read out actual files using, for example, a conventional Exif standard while providing an enhanced speed search function using the index file even if separate files for interchanging are not generated, and interchanging between different file formats can therefore be achieved in a straightforward manner at reduced cost.

Further, the input information reading mechanism 27 for the digital camera 1 constituting an electronic apparatus related to an example of preferred embodiment of the present invention and the reproduction mechanism 32 etc. read out actual files for, for example, still images based in information within read-in index files. It is therefore possible to search, for example, actual files for the still images using a conventional Exif standard generated so as to be compatible with information within the index file at enhanced speed using the index file.

The input information reading mechanism 27 of the digital camera 1 constituting an electronic apparatus related to an example of preferred embodiment of the present invention and the other types of apparatus reproduction mechanism 34 etc. read actual files for still images based on information within the read-in DCIM directory 40. It is made possible to therefore read out actual files for still images using the conventional Exif standard generated so as to be compatible with information within, for example, the index file using electronic apparatus following a conventional, for example, Exif standard, which enables straightforward interchangeability between different file formats so as to achieve reduced cost.

Further, the CPU 23 etc. of the digital camera 1 constituting an electronic apparatus related to an example of preferred embodiment of the present invention is capable of displaying an execution button 54 on an other types of apparatus reproduction menu screen at an image display mechanism 30 so as to enable selection of whether or not to read using, for example, a conventional Exif standard. Actual files for still images for input information generated under the DCIM directory 40 are read using information selected using the execution button 54. As a result, the actual file for a still image is first searched using an index file, for example, and a reproduction method can be selected in order to read the actual file so as to follow, for example, the conventional Exif standard as necessary afterwards. This increases interchangeability between different file formats.

The digital camera 1 constituting an electronic apparatus related to an example of preferred embodiment of the present invention has a reproduction mechanism 32, etc. for determining whether or not actual files, such as NRQ00001.JPG42, etc. are generated under the DCIM directory 40. In the event that it is determined that an actual file is not generated by the reproduction mechanism 32, the other types of apparatus reproduction menu screen displaying the execution button 54 is not displayed, unnecessary processing is avoided, and the user can easily be notified that the actual file is not present.

Further, the reproduction mechanism 32, etc. of the digital camera 1 constituting an electronic apparatus related to an example of preferred embodiment of the present invention is capable of determining whether or not an actual file has been generated under the DCIM directory 40 using information within the index file read in by the input information reading mechanism 27 etc. Therefore, by adding a flag showing that an actual file has not been generated at the property within, for example, the index file, it is made possible to easily determine whether an actual file has been generated by reading in the index file first. In this way, it is made possible to omit reading processing for the conventional Exif standard, and a higher reproduction processing speed is made possible.

Moreover, by having a computer execute a computer program for generating a first subdirectory, for example, MQ ROOT directory 36, relating an index file for input information under the root directory, and generating a second subdirectory, for example, a DCIM directory 40, relating at least part of an actual file for input information in parallel with this MQ ROOT directory 36, by using this computer program, it is made possible to read out actual files for still images using, for example, a conventional Exif standard while providing a enhanced speed search function using the index file even if separate files for interchanging are not generated, and interchanging between different file formats can therefore be achieved in a straightforward manner at reduced cost.

Further, by having a computer execute a computer program for reading a first subdirectory MQ ROOT directory 36, for example, generated so as to relate an index file for input information under the root directory, and reading a second subdirectory, such as a DCIM directory 40, generated so as to related at least part of an actual file for input information in parallel with this MQ ROOT directory 36, by using this computer program, it is made possible to read out actual files for still images using, for example, a conventional Exif standard while providing a enhanced speed search function using the index file even if separate files for interchanging are not generated, and interchanging between different file formats can therefore be achieved in a straightforward manner at reduced cost.

It can also be expected that media recording capacities will become larger in the future and that the number of files handled by users and electronic apparatuses will increase. Content management using index files, etc. will therefore become necessary, but the problem will be how to achieve exchangeability for still images, etc. adopting, for example, the Exif standard.

The present invention therefore has been conceived also to ensure that convenience is increased by handling both files of a conventional format and files employing index files with an interface that is easy to understand so as to minimize confusion to the user.

The present invention is by no means limited to any of the embodiments described above. Therefore, it should be understood by those of ordinary skill in the art, that, although the present invention having been described hereinabove in its preferred form with a certain degree of particularity in the present specification, other changes, variations, combinations, sub-combinations, etc. are possible therein. It is therefore to be understood that any modifications will be practiced otherwise than as specifically described herein without departing from the scope and spirit of the present invention.

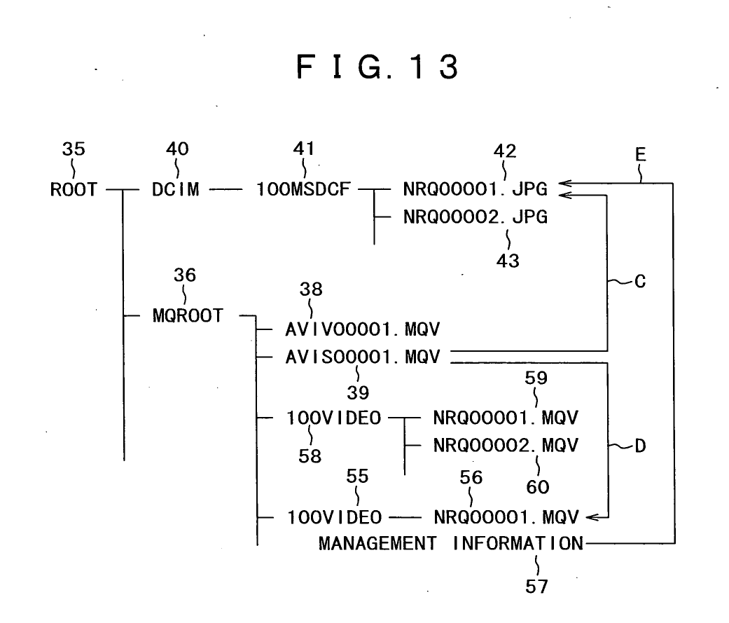

Here, FIG. 13 is a view describing a case of acquiring actual data for a still image via a file storing only management information using the index file information.

Further, the MQ ROOT directory 36 is a directory mainly for saving MQT method moving images, still images, audio, and music content and the electronic apparatus of the present invention, for example, the digital camera 1, records actual moving image files and moving image indexes under this directory while recording and playing back moving image files. In the case of acquiring read data for a still image via a file storing only management information using information on the index file described below, a description is given where, for example, AVIV00001.MQV38 constituting an index file for a moving image as shown in FIG. 13, 100VIDEO directory 58 constituting this subdirectory and NRQ00001.MQV59, etc., are recorded.

For example, in the examples of preferred embodiments described above, a description is given of the case (arrow C in FIG. 13) where information relating to an actual file NRQ00001.JPG42 for a still image stored in the property of index file AVIS00001.MQV39 is acquired, and actual data for NRQ00001.JPG42 is acquired via the DCIM directory 40 and the 100 MSDCF directory 41, but this is by no means limiting the scope of the present invention.

For example, as shown in FIG. 13, a 100STILL directory 55 is provided in parallel with AVIS00001.MQV39 under the MQ ROOT directory 36, under which ABCD0001.MQT56 that only stores management information 57 is provided.

With this directory structure, information relating to ABCD0001.MQT56 stored in the property of index file AVIS00001.MQV39 as shown by the arrow D in FIG. 13 is acquired, and ABCD0001.MQT56 is seen via the 100STILL directory 55.

Furthermore, it is also possible to acquire the management information 57 stored in ABCD0001.MQT56 as shown by arrow E in FIG. 13, and acquire actual data for NRQ00001.JPG42 via the DCIM directory 40 and the 100MSDCF directory 41 based on this management information 57.

As a result, a variety of index file structures can be achieved and compatibility with a variety of file processing is made possible.

Further, in an embodiment described above, determination is made in ST220 shown in FIG. 8 as to whether or not a still image file is present, but this is by no means limiting. For example, it is possible to make the CPU 23 cause display of other types of apparatus reproduction menu screen directly if it is determined in ST219 that the other types of apparatus reproduction button 53 are selected at the other types of apparatus reproduction mechanism 34. In the event that the execution button 54 of the other types of apparatus reproduction menu screen is selected, an actual file for a still image, for example, still image information for NRQ00001.JPG42 shown in FIG. 12, may be acquired based on a conventional Exif standard.

In the event that it is determined that an actual file does not exist for a still image at the other types of apparatus reproduction mechanism 34, the CPU 23 may advance to ST215 shown in FIG. 8 at the other types of apparatus reproduction mechanism 34. This achieves enhancement of speed of the reproduction of image information as a result of the number of processing steps being reduced.

In the examples of preferred embodiments described above, a directory/file generating mechanism 29, for example, is used as first means for generating MQ ROOT directory 36, AVIS00001.MQV38, etc., and the directory/file generating mechanism 29 is employed as second generating means for generating a DCIM directory 40 and an actual file for a still image NRQ00001.JPG42, for example, but this is by no means limiting, and generation may take pace using respective separate directory file generating mechanisms. Higher diversity of directory file generation is therefore possible as a result.

Further, in the above embodiments, data storage is not especially provided at the control unit 7 of the digital camera 1, but this is by no means limiting and, for example, data storage may be provided at the control unit 7, and may store generated index files and actual files for still images etc. As a result, it is made possible to achieve customization enabling reproduction of image information etc. for still images with freedom with respect to time and location.

1. An electronic apparatus comprising:
first generating means for generating a first subdirectory under a root directory for relating an index file of input information to the root directory; and
second generating means for generating under the root directory a second subdirectory in parallel with the first subdirectory relating at least a part of an actual file of the input information to the root directory.

2. The electronic apparatus according to claim 1, wherein:
said first generating means generates an index file under the first subdirectory; and
said second generating means generates at least part of an actual file of the input information under the second subdirectory.

3. The electronic apparatus according to claim 1, wherein said actual file corresponds to at least part of information within the index file.

4. The electronic apparatus according to claim 2, further comprising recording means configured to record at least said root directory, said first subdirectory generated by said first generating means and said index file, and said second subdirectory generated by said second generating means and said actual file on a portable recording medium.

5. The electronic apparatus according to claim 1, wherein said input information includes image information, and said second subdirectory is based on a standard for an image file format for use in a digital camera.

6. An electronic apparatus comprising:
first reading means configured to read a first subdirectory generated under a root directory relating an index file of input information to said root directory; and
second reading means configured to read a second subdirectory generated in parallel with said first subdirectory and relating at least part of an actual file of the input information to said root directory.

7. The electronic apparatus according to claim 6, wherein:
said first reading means reads said index file generated under the first subdirectory; and
said second reading means reads at least part of said actual file of the input information generated under said second subdirectory.

8. The electronic apparatus according to claim 7, wherein said second reading means reads said actual file based on information within said index file read by said first reading means.

9. The electronic apparatus according to claim 7, wherein said second reading means reads said actual file based on information within said second subdirectory read by said second reading means.

10. The electronic apparatus according to claim 9, wherein said second reading means further comprises selection means for selecting whether to read through said reading means, and reads said actual file of the input information generated under the second subdirectory using selection information from said selection means

11. The electronic apparatus according to claim 10, wherein said selection means further comprises determining means configured to determine whether an actual file has been generated under said second directory, and said selection means is restricted when said determining means determines that said actual file has not been generated.

12. The electronic apparatus according to claim 11, wherein said determining means is capable of determining whether an actual file is generated under said second subdirectory based on information within said index file read by said first reading means.

13. The electronic apparatus according to claim 6, wherein said input information includes image information, and at least said second subdirectory is based on a standard image file format for a digital still camera.

14. A directory generating method comprising:
a first generating step of generating a first subdirectory under a root directory for relating an index file of input information to the root directory; and
a second generating step of generating under the root directory a second subdirectory in parallel with the first subdirectory relating at least part of an actual file of the input information to the root directory.

15. A directory reading method comprising:
a first reading step of reading a first subdirectory generated under a root directory relating an index file of input information to said root directory; and
second reading step of reading a second subdirectory generated in parallel with said first subdirectory and relating at least part of an actual file of the input information to said root directory.

16. A computer-readable program for making a computer execute the steps of:
generating a first subdirectory under a root directory for relating an index file of input information to the root directory; and
generating under the root directory a second subdirectory in parallel with the first subdirectory relating at least part of an actual file of the input information to the root directory.

17. A computer-readable program for making a computer execute:
a first reading step of reading a first subdirectory generated under a root directory relating an index file of input information to said root directory; and
a second reading step of reading a second subdirectory generated in parallel with said first subdirectory and relating at least part of an actual file of the input information to said root directory.
